(19) United States
(12) Patent Application Publication
(10) Pub. No.: US 2018/0053204 A1
(43) Pub. Date: Feb. 22, 2018

(54) AUTO-POPULATION OF DISCOUNT INFORMATION INTO AN E-INVOICE

(71) Applicants: Bikash Mohanty, Mumbai (IN); Neha Kale, Mumbai (IN)

(72) Inventors: Bikash Mohanty, Mumbai (IN); Neha Kale, Mumbai (IN)

(21) Appl. No.: 15/239,912

(22) Filed: Aug. 18, 2016

(51) Int. Cl. G06Q 30/02; G06Q 30/04

(52) U.S. Cl. CPC G06Q 30/0239; G06Q 30/04

(57) ABSTRACT

Systems and processes for transformation of contractual free text discount information into discount amount, wherein external contract templates are uploaded into a contract management system. Discount related free text clauses are extracted from uploaded contracts by clicking on discount related clauses. Storing means store the extracted clauses tagged to the contract identify by mapping of the field, followed by generation of an e-invoice by pulling the information from contract management into relevant discount information on a supplier portal for creating the invoice. An e-invoice template is filled up with contract identity, followed by mapping of the extracted discount related clauses tagged to that contract, which is stored in the contract management storing system. The system analyzer calculates the discount amount, and transfers same to the requisite field of the invoice template of the e-invoice system. Final calculation of invoice amount is done by the e-invoice system to generate invoice amount.

### FIELD OF THE INVENTION

The invention relates in general to electronic procurement and more particularly to a system and method for transformation of contractual free text discount information into discount amount in an e-invoice.

### BACKGROUND OF THE INVENTION

Contracts are often required in business-to-business transactions. As merely an example, contracts are often required during the procurement of materials and services. As another example, contracts are often required during the sales process.

In the e-procurement process, user/buyer selects items, i.e., goods or services from the catalogue of suppliers and sends purchase order to the supplier. Once the purchase order is received, an invoice is generated and sent to the user/buyer. The user may then make payment by way of electronic banking, wherein payment instructions are sent electronically from the individual's computer system to the individual's bank. Payment is later effected by the bank.

There are numerous systems which can track information related to accounting and bill payment. For instance, computer software is used to track invoices and print payment checks. Payments made be made by wire transfer, with instructions requesting funds of the payer in one financial institution to be transferred to an account of the party to whom payment is to be effected.

Traditionally, the supplier was generating invoices by entering the information of items that were purchased by the user/buyer to the supplier. This had a disadvantage that the supplier had to take duplicate data entry effort since items information was already available in the purchase order. Although, there are some systems implemented for creating invoice from image scanning of invoice as well as some portals which do exchange purchase orders and invoices between user/buyer and supplier/vendor, none of the system is adapted for copying items information from purchase order into invoices.

Such systems require considerable amounts of effort to update and maintain the records and these systems lacks compatibility with the other systems used by parties with whom an organization wishes to engage in transactions.

U.S. Patent Application Publication No. 20050283437 discloses a computer implemented business method in an electronic system in which payment information is exchanged between a buyer and a seller. Approval is received from the buyer of an electronic invoice received by the buyer. At a time when no agreed upon discount is available based on the invoice or pre-agreed terms between the buyer and the seller, a request is received from the buyer to offer the seller early payment in exchange for a discount of the amount owed. The discount is based on an annual hurdle rate provided to the system by the buyer. The offer is presented to the seller on the seller's user interface, and a clickable button is provided for the seller to indicate selection of such offer.

U.S. Patent Application Publication No. 20140297369 discloses a method, system, and medium for generating a double-probability-weighted discount for lack of marketability (DLOM) for an asset to be valued. Selections of parameters associated with the asset to be valued and of representative assets for which price data is available are received. A mean and standard deviation of marketing periods associated with the selected parameters and of price, volatilities depicted by the price data are calculated. A statistical modeling application generates probability distributions based on the means and standard deviations of the marketing periods and of the price volatilities. DLOMs are calculated for each combination of marketing period and price volatility. The DLOMs are weighted based on the probabilities depicted by the probability distributions and summed to provide the double-probability-weighted DLOM, which is presented to the user via a user interface.

U.S. Patent Application Publication No. 20130317894 discloses an approach for template-based discount valuation and ranking. A discount management platform processes or facilitates a processing of a vocabulary for representing one or more parameters of discount information associated with one or more discount types. The discount management platform then processes or facilitates a processing of the one or more discount types to generate one or more templates based, at least in part, on the vocabulary.

Published PCT International Patent Application No. WO2012141985 describes systems and methods that balance commercial margin compared to a target customer value to satisfy a purchase request for a plurality of articles. An original selling price for a purchase request items is calculated, the initial sale price is based on a sum of retail prices for the items, which have been a discount equivalent to a target customer value predetermined. An initial margin for the application is determined, based on the sum of the retail price for items less a sum of predetermined contract pricing for the items.

The prior art has the following limitations: (1) More efforts are required to update and maintain the systems; (2) They lack compatibility with the systems used by parties with whom an organization wishes to engage in transactions; and (3) Failure to provide information about discount and if it provides, it is manually inserted into the invoice.

Therefore, to overcome the limitations of the prior arts, the present invention proposes a system for flipping/transforming the specific discount related information from the specific e-contracts stored in a contract management information system into specific discount related information on an e-invoice present in an e-invoicing system.

### SUMMARY OF THE INVENTION

The main objective of the present invention is to provide provides the system for flipping/transforming the specific discount related information from the specific e-contracts stored in contract management information system into specific discount related information on an e-invoice present in an e-invoicing system.

Another primary object of the present invention is to provide a choice to the user/buyer to modify the fields, which are variable.

In accordance to the present invention, the system for flipping/transforming the specific discount related information from the specific e-contracts stored in a contract management information system into specific discount related information on an e-invoice present in an e-invoicing system. The system supports auto-populating relevant discount related information present in a specific contract into the relevant fields of an e-invoicing system, while creating an e-invoice related to that contractual transaction, in the e-invoicing system.

Further, the system provides options to a user/buyer to modify the variable fields. For instance, a unit price field is variable and the user can modify the number of items that are to be purchased.

In accordance with the present invention, the system has external contract templates, which are uploaded into the contract management system. Discount related free text clauses are extracted from the uploaded contracts, by the user clicking discount related clauses. Storing means of the present system stores the extracted clauses tagged to the contract identity (“ID”) by mapping of the field followed by generation of an e-invoice from the e-invoice generating system. Further, the e-invoice template is filled up with contract ID followed by mapping of the extracted discount related clauses tagged to that contract which is stored in the contract management storing system.

The system's analyzer is based on inputs and calculates the discount amount and transfers same to the requisite field of the invoice template of the e-invoice system. Final calculation of invoice amount is done by the e-invoice system to generate an invoice amount.

These and other objects and advantages of the present invention will become apparent from a reading of the following specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A complete understanding of the present invention may be by reference to the following detailed description which taken in connection with the accompanying drawings.

FIG. 1 is a screen capture of an illustrative format of an e-contract containing the normal paragraphs and clauses describing discount related information.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well-known features are omitted or simplified in order not to obscure the present invention.

In accordance to the present embodiment of the present invention, there is a system and a process for transformation of contractual free text discount information into discount amount.

In accordance with the present embodiment of the present invention, a system and method for transformation of contractual free text discount information into discount amount in an e-invoice. This integration will help in auto-populating relevant discount related information present in specific contracts into the relevant fields of an e-invoicing system while creating an e-invoice related to that contractual transaction, in the e-invoicing system.

Before storing any e-contract into the contract management system, a metadata form is required to be filled in. Metadata is the relevant information captured on an EXCEL sheet within the software tool which helps in contract creation and searching a contract in the contract management information system software tool. The discount information from the metadata of the contracts present in the contract management information system will flow into the relevant fields of the e-invoice. Mapping of the metadata information of contracts is accomplished with the relevant fields of the e-invoice based on decision rules. There may be thousands of contract on the basic EXCEL sheet on which some common fields are enumerated to capture common information present in the contracts. Before uploading, e.g., 500 odd contracts into the contract management tool, certain common fields are mentioned on the EXCEL sheet, contract information is provided against those common fields by reading each contract. The common fields are decided according to the needs of the user.

The following is a list of fields for providing information on the metadata form and which is used for mapping of metadata information.

List of fields

Contract category, e.g., Vendor
Contract ID
Contract sub category, e.g., Admin, MARCOM, HR
Contract title
date of contract
product type
discount amount/rate of discount
supplier name
Value of contract
Contract Number
Contract status
Start date, expiry date, renewal
Supplier name
Payment terms
Total value
Stake holder information
Contract contact person
Signing authority
Authoritative information
Jurisdiction
Arbitration allowed
Signing authority

Once the above list of fields information is collected on the EXCEL sheet for all the contracts, all the relevant external contracts are uploaded. Further, these external contracts are uploaded into the contract management tool. This tool has a click option for the user to opt, extract payment terms/discount related clauses, or any other specific clause or all clauses of the contract.

The metadata information is also used to flip into a contract template with necessary information; thereafter-necessary clauses to the contract can be further added from the contract management information system tool to complete the contract.

Conventionally, to provide information about discounts, it was required to see the contract, then manually insert related discount information into relevant field of the invoice. It might skip many times also, so in order to avoid such issues, this invention is very useful. Each of the common fields mentioned in the said metadata form have an ID mentioned to each such field. Metadata captured on the contract management information system tool provides important fields including contract type, supplier name, discount amount, rate of discount, product type, no of products, product specifications, and payment terms.

In accordance to one of the embodiment of the present invention, the information required to be input or added to a sourcing tool, is the RFQ (Request for quotation) information having information in some other format and further the fields have some other names. Thus, the mapping of fields is required to have the desired corresponding information into the relevant fields of invoice. The common ID is assigned to each such fields discount information on a particular contract, and a common ID with that of the field discount mentioned on the web e-invoice form so that appropriate information can flow in. Therefore, there are various decision rules to assign such common ID's. Once the ID's are matched appropriate information flows and the contract tool shall then have a mechanism to flip the information captured in the metadata of the contract into relevant discount information on an e-invoice.

In accordance to another embodiment of the present invention, the integration is between contract management and an e-invoice. However, it has the possibility to be integrated with other third party portals tools to pull the information from contract management into supplier portal for creating invoice.

In accordance to another embodiment of the present invention, system has a method for extraction of clauses from any external contract document. The received external contract document by the system may typically comprise a plurality of clauses arranged in flowing paragraphs, spanning multiple pages. The clauses includes contractual terms, payment terms, references to other documents, etc.

In some external contract, the clauses are organized into sections and titles for improved readability, for instance, it has contract title, section title, clause title and clause text. However, in few other external contracts, there may not be such organization and the clauses may be free flowing. Thus, in the present invention, processing of the received contract document is carried out in order to extract clauses into section, titles etc. The information extraction module performs this extraction task. For the purpose of information extraction, the present invention utilizes certain heuristics. The heuristics can be pre-configured in the system. Users can also provide their own heuristics or alter the pre-configured heuristics to suit particular contract document.

For effective processing, the system of the present invention logs various text string patterns that are reclassified by the end user manually, based on which the system generate new or modified versions of the existing heuristics (assumptions). The system administrator has the ability to review these new or modified heuristics and assign a confidence value to each. An exemplary technique for information extraction is as described below: The new or modified heuristics includes following: (1) The smallest unit of the contract is a clause; (2) One or more clauses may have clause titles; (3) Clauses may or may not be grouped into sections. The section may have a title; (4) A contract as a whole may have a title; (5) Clauses, clause titles, section titles, and contract title can be distinguished based on font style. The font style can comprise one or more of font face, font family, font size, and font texture (bold, underlined, italics, etc.); (6) The text style that is used most frequently can be considered as clause text; (7) The text style that is found to precede the clause text most frequently can be considered as the clause title; (8) If there is no specific text style preceding the clause text, check if the clause title is a group of words in capital case at beginning of the clause text; (9) If clause title is found, then the text style that is found to precede the clause title most of the times can be considered as the section title; and (10) The contract title can be the text, which is found at the beginning of the document, or it can be the text with the largest font size in the document.

It is obvious to the person skilled in the art to understand that the above-mentioned heuristics are for exemplary purpose only. Alternative heuristics can be used in addition to or in lieu of the specific technique described above. For example, the text string pattern matching can include identifying specific key words (e.g., discount, payment terms, normal discount, special discount, volume discount, concession, rate of discount, etc.) in the contract document to identify certain portion or type of text in the document.

In accordance to another embodiment of the present invention, the system of the present invention can log various text string patterns that are manually classified by the user, based on which the system can generate new or modified versions of the existing heuristics.

In accordance to another embodiment of the present invention, the extracted information can be presented to the user in a classified form.

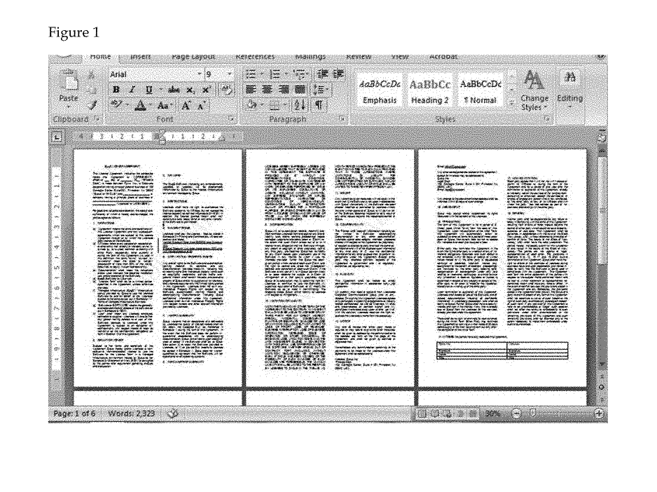

Referring FIG. 1 that depicts the structure of the contract that is extracted or interpreted, presented in the form of tree structure. The method facilitates the user to review the extracted information. It provides for the user to review the classification of text, rectify any misclassified text, assign category to unclassified text and like.

In accordance to another embodiment of the present invention, the system of the present invention has a storing system or means to store extracted clauses tagged to the contract category and ID's. Following are the steps for generation of discount related information into the e-invoice of the invoicing system: (1) The relevant discount related clause is extracted from the contracts; (2) These extracted clauses are stored in the contract management tool tagged to the contract category and contract ID; (3) In each invoice template before generation or finalization, contract number is inserted which is tagged with the contract ID and the invoice template provided with the inputs of contract ID is then subjected to mapping for generating the discount amount; (4) The discount related clause so extracted from the above mentioned steps and which are stored as mentioned above in the storing system of contract management tool are further utilized while generating invoice in the e-invoice system, related to the transaction connected to that contract; (5) The key words present in the discount/payment terms are extracted and analysed by the system to decide which discount module will be adhered, whether volume discount module or early payment discount module; and (6) By mapping of words and heuristics, the system of the present invention recognizes the discount clause to be either volume discount module or early payment discount module.

In accordance to the present invention, the system recognizes the volume module to be a “volume discount,” then further actions for the volume discount module will be as follows: (1) Volume discount module: Discount clause extracted and stored in the storing system of contract management tool and tagged to a specific contract ID may contain following wordings. For instance, “Discount at volume more than 2000, will have a discount of 5%.” In the e-invoicing system for generating invoice, the contract ID is inserted in the invoice template. On insertion of the contract ID, the e-invoicing system maps the contract ID on the contract management tool and subsequently maps the discount related clause stored in the storing system of the contract management information system tool. Further, on mapping of the discount related clause, mapping of words/heuristics are done within the discount clause like discount, volume, percentage etc., are captured by the system analyser; (2) If the inputs captured indicate the word ‘volume,” the system is trained to recognize this as “volume discount model.” Accordingly, the system maps the input of volume inserted into the invoice field and checks if the invoice field has inserted a volume in excess of 2000 units. If yes, then it will include 2% as a discount, calculate the total discount amount by mapping to the total invoice value, and the generate the discount amount into the e-invoice template of the e-invoicing tool; (3) Further, if the inputs do not include any wordings like “volume” or “units” or other synonyms then the system will analyse other wordings fed into the system to suggest that this is early payment discount; (4) Early Payment Discount: This type of discount is a very basic prorated discount agreed between the supplier and buyer. For example “2% 10 Net 30” means the full amount is due on the 30th day from the Invoice Date or the amount after the 2% discount is due on the 10th Day. Hence, the supplier is providing a 2% discount against the 20-day (30-10 days) early payment; (5) If the inputs does not include any wordings like volume or units or other synonyms, then the system will analyse other wordings of the discount clause fed into the system to suggest that this is an early payment discount option. Hence, it will insert the recognized part of discount terms (E.G., 2% 10 Net 30) within the discount fields of the invoice of the e-invoice tool and not the amount. In such a scenario, if this option later is exercised by the supplier or buyer within the e-invoicing system, then this term present in the e-invoice will be mapped by the additional document and the system will calculate the discount amount and generate same in the additional document. This additional document depicting the discount amount will remain tagged to the original invoice for record purposes; and (6) If there is no discount clause, tied to the contract for which the e-invoice is raised, then the system will tag an alert to the invoice that if needed a dynamic discount proposal can be provided.

Further, based on the above-mentioned steps, free text discount information/data is transformed into an actual discount amount and is captured into the e-invoice template, wherein the invoice amount is finalized.

In accordance to the another embodiment of the present invention, the e-contracts are stored in a contract management information system tool, which has various legal and commercial clauses. Hence, the discount related information is present in the contract like any normal paragraph/clause. Thus, the format in which the discount related information is stored in e-contract is any normal paragraph/clauses and the format of econtract containing the discount related information/data is normal paragraph/clause. The format of e-contract containing the normal para/clause describing discount related information is indicated in FIG. 1. Thus the e-contract format containing discount clause/data, this clause containing discount information, needs to be transformed into suitable discount format (e.g., discount amount or discount percentage) to be included in the e-invoice template for depicting the discount amount or discount % and calculating the same to reflect the final discounted price that is the final invoice amount due for payment.

In accordance to another embodiment of the present invention, the system of the present invention includes a communication interface for accessing the host computer system from a plurality of remote input/output devices like mobile, iPad etc., to manage the business process element as described above.

While the invention is described and illustrated here in the context of a limited number of embodiments, the invention may be embodied in many forms without departing from the spirit of the essential characteristics of the invention. The illustrated and described embodiments, including what is described in the abstract of the disclosure document, are therefore to be considered in all respects as illustrative and not restrictive. The scope of the invention is indicated by the appended claims rather than by the forgoing description, and all changes, which come within the meaning and range of equivalency of the claims are intended to be embraced therein. While considerable emphasis has been placed herein on the structures and structural interrelationships between the component parts of the preferred embodiments, it will be appreciated that many embodiments can be made and that many changes can be made in the preferred embodiments without departing from the principals of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. An integrated portal system for automatically populating discount related data on an e-invoice, comprising:
a contract management information system for storing specific discount related information from specific stored e-contracts;
an e-invoicing system, wherein the specific discount related information on the e-invoice is present;
at least one configurable and nameable business process element;
a communication interface for accessing a host computer system from a plurality of remote input/output devices to manage the business process element;
a flipping system adapted to transform the discount related information from contract management into the e-invoice of an invoicing tool;
wherein an integrated portal system transforms the specific discount related information from the stored specific e-contracts into the specific discount related information on the e-invoice.

2. A process for transformation of contractual free text discount information into discount amount and/or requisite discount data in an e-invoice, comprising the steps of:
extraction of discount related free text clauses from e-contracts uploaded into a contract management system;
mapping of heuristic words from the extracted discount clauses;
selection of a discount module by an integrated portal system from a volume discount module or an early payment discount module;
transforming the discount related information from contract management into an e-invoice by a flipping system.

3. The process as claimed in claim 2, wherein an external contract template is uploaded into the contract management system when all the information is provided within computer program instructions.

4. The process as claimed in claim 2, wherein the discount related free text clauses are extracted from uploaded contracts by a user clicking discount related clauses.

5. The process as claimed in claim 2, wherein the extracted clauses are tagged to a contract identity by mapping of a field such that desired corresponding information flows into relevant fields of an invoice by assigning common identifiers to such fields.

6. The process as claimed in claim 2, wherein the e-invoice is generated from an e-invoicing system by pulling the information from contract management into relevant discount information for creating the invoice.

7. The process as claimed in claim 2, wherein the extracted clauses are tagged with the contract identity, wherein mapping generates the discount amount by providing an invoice template with the inputs of contract identities.

8. The process as claimed in claim 2, wherein the mapping of contract identity of the e-invoice with the contract identity of a particular contract present in the contract management is followed by mapping of heuristics and requisite words related to a selection of requisite discount modules that includes selection of at least one volume discount module or an early payment discount module.

9. The process as claimed in claim 2, wherein based on the selected discount module, at least one action is performed to provide requisite discount related information to the e-invoice of an invoicing tool.

10. The process as claimed in claim 2, wherein the free text discount information is transformed into an actual discount amount and captured into the e-invoice template through which an invoice amount is calculated by the e-invoice system.
